(19) United States
(12) Patent Application Publication
(10) Pub. No.: US 2021/0006112 A1
(43) Pub. Date: Jan. 7, 2021

(54) ROTARY ELECTRIC MACHINE

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Naoya SASAKI, Gifu (JP); Hiroaki MAKINO, Fuchu (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 17/026,385

(22) Filed: Sep. 21, 2020

Related U.S. Application Data
(63) Continuation of application No. PCT/JP2018/032650, filed on Sep. 3, 2018.

(30) Foreign Application Priority Data
Mar. 30, 2018 (JP) 2018-066977

(51) Int. Cl. H02K 1/27

(52) U.S. Cl. CPC H02K 1/276; H02K 2213/03

(57) ABSTRACT

According to one embodiment, a rotor core of a rotor includes, in each magnetic pole, two embedding holes on sides of a d-axis, in which respective permanent magnets are loaded, respectively, and grooves formed in an outer circumferential surface in positions each including respective q-axes. When A represents a pole arc degree of the grooves along the outer circumferential surface, B represents a depth of the grooves, C represents a pole arc degree, and R represents a circumradius tangent to an outer circumference of the rotor core, each grooves is formed to satisfy relationships: 0.05<A<0.075 and 0.005<B/R<0.027.

### CROSS-REFERENCE TO RELATED APPLICATIONS

This application is a Continuation Application of PCT Application No. PCT/JP2018/032650, filed Sep. 3, 2018 and based upon and claiming the benefit of priority from Japanese Patent Application No. 2018-066977, filed Mar. 30, 2018, the entire contents of all of which are incorporated herein by reference.

### FIELD

Embodiments described herein relate generally to a rotary electric machine in which a permanent magnet is provided on a rotor.

### BACKGROUND

Recently, research and development of permanent magnets have been remarkably advanced, and permanent magnets of high magnetic energy product are developed. Permanent magnet-type rotary electric machines which employ such a permanent magnet are applied as electric motors or power generators of electric trains and vehicles. Generally, a permanent magnet-type rotary electric machine comprises a cylindrical hollow stator and a columnar rotor rotatably supported inside the stator. The rotor comprises a rotor core and a plurality of permanent magnets embedded in the rotor core.

For such permanent magnet-type rotary electric machines, it is proposed that a pair of permanent magnets are arranged to open symmetrically towards an outer circumferential surface side from an inner circumferential surface side in each magnetic pole, so as to create a magnetic circuit which can utilize reluctance torque in addition to magnet torque.

When a rotary electric machine is used as a drive source of a moving body such as a vehicle, it is required for the rotary electric machine to have high efficiency to improve energy consumption.

### BRIEF DESCRIPTION OF THE DRAWINGS

FIG. 1 is a cross-section view of a permanent magnet-type rotary electric machine according to an embodiment.

FIG. 2 is a partially enlarged cross sectional view of a rotor of the rotary electric machine.

FIG. 3 is a perspective view showing a rotor core and permanent magnets of the rotary electric machine.

FIG. 4A is a diagram showing a relationship between a pole arc degree of grooves and (transfer change ratio/torque change ratio).

FIG. 4B is a diagram showing a relationship between the pole arc degree of the grooves and the efficiency of the rotary electric machine.

FIG. 5 is a diagram showing a relationship between the depth of the grooves in the rotor core and the efficiency.

FIG. 6 is a diagram showing a relationship between a ratio (B/R) of a groove depth B to a circumradius R of the rotor core and an iron loss.

FIG. 7 is a diagram showing a relationship between a ratio (B/R) of a groove depth B to a circumradius R of the rotor core and a copper loss.

FIG. 8 is a diagram showing a relationship between a ratio (B/R) of a groove depth B to a circumradius R of the rotor core and a motor loss.

FIG. 9 is a partial cross sectional view schematically showing a stator core.

FIG. 10 is a diagram showing change ratios of the Joule heat loss in a plurality of sites of the rotary electric machine.

### DETAILED DESCRIPTION

Embodiments will be described hereinafter with reference to the accompanying drawings.

In general, according to one embodiment, a rotary electric machine comprises a stator and a rotor provided ratatably around a central axis, the rotor comprising a rotor core comprising an outer circumferential surface opposing the stator with a gap therebetween and a plurality of magnetic poles arranged along the outer circumferential surface, and a plurality of permanent magnets provided in each of the plurality of magnetic poles, the rotor being provided rotatably around a central axis. Where, in the rotor core, axes each radially extending to pass through a boundary between each respective adjacent pair of two magnetic poles and the central axis, are represented by q-axes, and axes at an electrical angle of 90 degrees with respect to the respective q-axes are represented by d-axes, the rotor core comprises, in each magnetic pole, two embedding holes provided on respective sides of the respective d-axis, in which the respective permanent magnets are loaded, respectively, and a plurality of grooves formed in the outer circumferential surface in positions including the respective q-axes to project to an inner circumferential side of the rotor core. The two embedding holes and two permanent magnets each comprise an inner circumferential-side edge adjacent to the respective d-axes and an outer circumferential-side edge adjacent to the outer circumferential surface, being arranged to be line symmetrical with respect to the respect d-axis and also such that a distance from the respective d-axis gradually expands from the inner circumferential-side edge towards the outer circumferential-side edge. Where A represents a pole arc degree of the grooves along the outer circumferential surface, B represents a depth of the grooves from the outer circumferential surface, and R represents a circumradius tangent to an outer circumference of the rotor core, each of the grooves is formed to satisfy relationships: 0.05<A<0.075, and 0.005<B/R<0.027.

Various embodiments will be described below with reference to the drawings. Throughout the embodiments, common configurations are given the same symbol, and duplicated explanations are omitted. Each figure is a schematic view for explaining the embodiments and facilitating understandings thereof, and the shape, the dimension, the ratio and the like in the figure may be different from those of the actual apparatus, but they can be appropriately designed and changed by referring to the following descriptions and publicly known techniques.

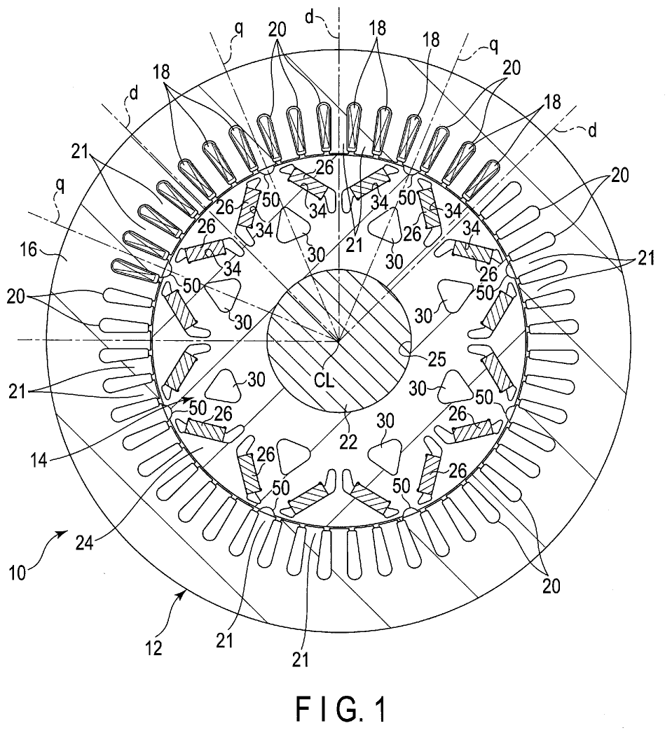

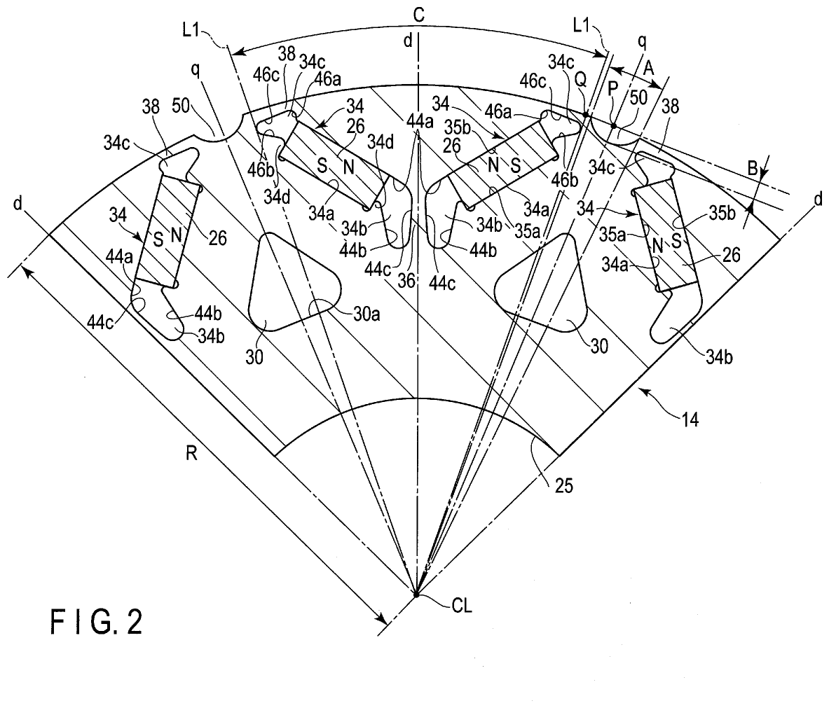

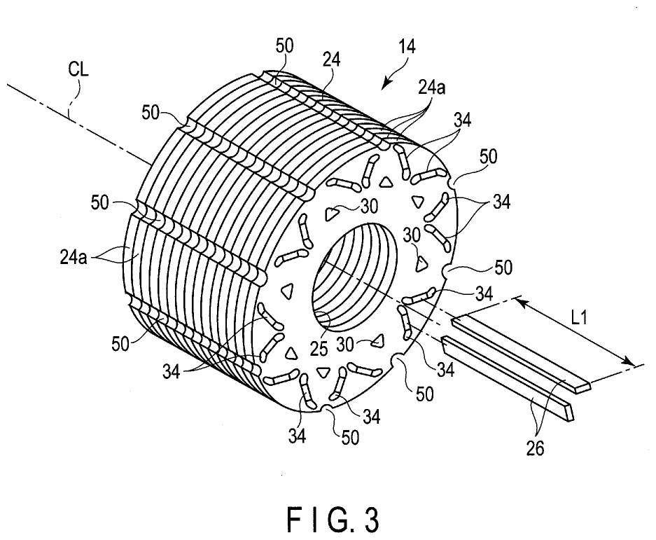

FIG. 1 is a cross-sectional view of a permanent magnet-type rotary electric machine according to an embodiment. FIG. 2 is a partially enlarged cross sectional view of a rotor thereof. FIG. 3 is a perspective view showing the rotor.

As shown in FIG. 1, a rotary electric machine 10 is configured as, for example, an inner rotor-type rotary electric machine, and comprises an annular or cylindrical stator 12 supported on a fixed frame (not shown) and a rotor 14 supported inside the stator 12 so as to be rotatable around a central axis CL and coaxially with the stator 12. The rotary electric machine 10 is applicable to, for example, a drive motor or a power generator in hybrid vehicles (HEV) and electric vehicles (EV).

The stator 12 comprises a cylindrical stator core 16 and an armature coil 18 wound around the stator core 16. The stator core 16 is prepared by laminating a great number of cylindrical electromagnetic steel plates of a magnetic material such as silicon steel, coaxially one on another. In an inner circumferential portion of the stator core 16, a plurality of slots 20 are formed. The slots 20 are arranged along a circumferential direction at equal intervals. Each slot 20 is opened in an inner circumferential surface of the stator core 16 and extends radially from the inner circumferential surface. Further, each slot 20 extends over a full axial length of the stator core 16. With the plurality of slots 20 thus formed, the inner circumferential portion of the stator core 16 are formed into a plurality of (for example, forty eight in this embodiment) stator teeth 21 facing the rotor 14. The armature coil 18 is embedded in a plurality of slots 20 and wound around each of the stator teeth 21. When applying current to the armature coil 18, a predetermined flux linkage is formed in the stator 12 (the stator teeth 21).

As shown in FIGS. 1 and 3, the rotor 14 includes a columnar shaft (rotating shaft) 22, both ends of which are rotatably supported by bearings (not shown), a cylindrical rotor core 24 fixed to, substantially, a axial central portion of the shaft 22 and a plurality of permanent magnets 26 embedded in the rotor core 24. The rotor 14 is disposed coaxially inside the stator 12 with a slight gap therebetween. In other words, an outer circumferential surface of the rotor 14 opposes the inner circumferential surface of the stator 12 with a slight gap therebetween. The rotor core 24 comprises an inner hall 25 formed coaxially with the central axis CL. The shaft 22 is passed through the inner hall 25 to engage therewith, and extend coaxially with the rotor core 24. The rotor core 24 is configured as a layered body in which a great number of annular electromagnetic steel plates 24a of a magnetic material such as silicon steel are coaxially laminated.

In this embodiment, the rotor 14 is set to be a plurality of, for example, eight magnetic poles. In the rotor core 24, axes each passing through a boundary between each respective adjacent pair of magnetic poles and the central axis CL to extend in a diametrical direction or a radial direction are referred to as q-axes and axes each located at an electrical angle of 90 degrees with respect to the respective q-axis are referred to d-axes (magnetic polar central axes). Here, the q-axes are set along directions in which the flux linkage to be formed by the stator 12 easily flow. The d-axes and the q-axes are provided alternately along a circumferential direction of the rotor core 24 in a predetermined phase. One magnetic pole of the rotor core 24 refers to a region between adjacent q-axes (an octant angular region). Thus, the rotor core 24 is configured as octapolar (eight magnetic poles). A circumferential center of one magnetic pole is a d-axis.

As shown in FIGS. 1 and 2, in the rotor core 24, two permanent magnets 26 are embedded in each magnetic pole. In the circumferential direction of the rotor core 24, magnet embedding holes (to be referred to as embedding holes hereinafter) 34 having a shape corresponding to that of the permanent magnets 26 are made on both sides of each d-axis. Two permanent magnets 26 are respectively loaded and placed in these embedding holes 34. The permanent magnets 26 may be fixed to the rotor core 24 by, for example, adhesive or the like.

The embedding holes 34 each extend and penetrate through the rotor core 24 in its axial direction. The embedding holes 34 have substantially a rectangular cross section which is inclined to the respective d-axis. When viewed in a cross section normal to the central axis CL of the rotor core 24, each pair of two embedding holes 34 are arranged in, for example, substantially a V-shape manner. More specifically, inner circumferential edges of each pair of two embedding holes 34 are located close to the respective d-axis and also to oppose each other with a slight gap therebetween. In the rotor core 24, a narrow magnetic path slender portion (bridge portion) 36 is formed between inner circumferential-side edges of each pair of two embedding holes 34. Outer circumferential-side edges of the two embedding holes 34 are located distant from the respective d-axis along the circumferential direction of the rotor core 24, but close to the outer circumferential surface of the rotor core 24 and the respective q-axis. With this arrangement, the outer circumferential-side edge of each embedding hole 34 is disposed to oppose the outer circumferential-side edge of the respective embedding hole 34 of the adjacent magnetic pole while interposing the respective q-axis therebetween. In the rotor core 24, a narrow magnetic path slender portion (bridge portion) 38 is formed between the outer circumferential-side edge of each of the embedding holes 34 and the outer circumferential surface of the rotor core 24. With this arrangement, each pair of two embedding holes 34 are disposed in such a manner that the distance from the respective d-axis gradually expands from the inner circumferential-side edge towards the outer circumferential-side edge.

As shown in FIGS. 2 and 3, the permanent magnets 26 are loaded to the respective embedding holes 34 and thus embedded in the rotor core 24. The permanent magnets 26 each are formed into, for example, a slender flat plate having a rectangular cross section, a first surface and a second surface (rear surface) opposing parallel to each other and a pair of side surfaces opposing to each other. The permanent magnets 26 each has a length L1, which is substantially equal to the axial length of the rotor core 24. The permanent magnets 26 each may be formed from a plurality of separate magnets combined along the axial direction (longitudinal direction), in which case, a total length of these magnets is set substantially equal to the axial length of the rotor core 24. Each permanent magnet 26 is embedded over substantially a full length of the rotor core 24. A magnetization direction of the permanent magnets 26 is a direction normal to the surface and the rear surface of each of the permanent magnets 26.

As seen in FIG. 2, the embedding holes 34 each further comprise a loading region 34a of a rectangular shape corresponding to the cross-sectional shape of the permanent magnets 26, two cavities (an inner circumferential-side cavity 34b and an outer circumferential-side cavity 34c) respectively extend from both longitudinal ends of the loading region 34a, and a pair of locking projections 34d projecting from an inner circumferential-side edge surface 35a of the respective embedding hole 34 into the respective embedding hole 34 in both longitudinal ends of the loading region 34a.

The loading region 34a is defined between the respective flat rectangular inner circumferential-side edge surface 35a and the respective flat rectangular outer circumferential-side edge surface 35b opposing parallel to the inner circumferential-side edge surface 35a. The inner circumferential-side cavity 34b is defined by a first inner surface 44a, a second inner surface 44b and a third inner surface 44c. The first inner surface 44a extends from one end of the outer circumferential-side edge surface 35b of the loading region 34a (an end on a respective d-axis side) towards the respective d-axis. The second inner surface 44b extends out from one end edge of the inner circumferential-side edge surface 35a of the loading region 34a (an end on a respective d-axis side, that is, the locking projection 34d edge) towards the central axis CL of the rotor core 24 so as to be substantially parallel to the respective d-axis. The third inner surface 44c extends over to an extending end of the first inner surface 44a and an extending end of the second inner surface 44b so as to be substantially parallel to the respective d-axis. Note that both ends of the third inner surface 44c are connected to the first inner surface 44a and the second inner surface 44b, respectively, via a circular arc surface. The inner circumferential-side cavities 34b of each pair of two embedding holes 34 are arranged in such a manner that the third inner surfaces 44c thereof oppose each other while interposing the respective d-axes and bridge portion 36 therebetween.

The outer circumferential-side cavity 34c is defined by the first inner surface 46a, the second inner surface 46b and the third inner surface 46c. The first inner surface 46a extends from the other end of the outer circumferential-side edge surface 35b of the loading region 34a (an end on an outer circumferential surface side of the rotor core) towards the outer circumferential surface of the rotor core 24. The second inner surface 46b extends from the other end of the inner circumferential-side edge surface 35a of the loading region 34a (an end on an outer circumferential surface side of the rotor core, that is, the locking projection 34d) towards the outer circumferential surface of the rotor core 24. The third inner surface 46c extends over the extending end of the first inner surface 46a and the extending end of the second inner surface 46b along the outer circumferential surface of the rotor core 24. The bridge portion 38 is defined between the third inner surface 46c and the outer circumferential surface of the rotor core 24.

The inner circumferential-side cavity 34b and the outer circumferential-side cavity 34c function as a flux barrier which suppress the leaking of magnetic flux from both longitudinal ends of the respective permanent magnet 26 to the rotor core 24 and also contribute to reduction of the weight of the rotor core 24.

The permanent magnet 26 is loaded in the loading region 34a of the respective embedding hole 34, and the first surface abuts against the inner circumferential-side edge surface 35a and the second surface abuts against the outer circumferential-side edge surface 35b. A pair of corner portions of the permanent magnet 26 each abut against the locking projection 34d. With this structure, each permanent magnet 26 is positioned in the respective loading region 34a. The permanent magnets 26 may be fixed to the rotor core 24 by an adhesive or the like. A pair of two permanent magnets 26 located on respective sides of each d-axis are arranged in substantially a V-shape manner. More specifically, the two permanent magnets 26 are disposed such that the distance from the respective d-axis gradually expands from the inner circumferential-side edge towards the outer circumferential-side edge.

Each permanent magnet 26 is magnetized to a direction perpendicular to the first surface and the second surface. Each respective pair of two permanent magnets 26 located on respective sides of the respective d-axis, that is, two permanent magnets 26 constructing one magnetic pole are disposed so that the magnetization directions thereof are the same as each other. On the other hand, each respective pair of two permanent magnets 26 located on respective sides of the respective q-axis are disposed so that the magnetization directions thereof are reversed. With the above-described arrangement of these permanent magnets 26, in the outer circumferential portion of the rotor core 24, the region on each d axis forms one magnetic pole 40 at a center and the region on each q-axis forms an inter-magnetic pole region 42 at a center. In this embodiment, the rotary electric machine 10 is configured as a permanent magnet-embedded rotary electric machine with eight poles (four pairs of poles) and forty eight slots, in which the front and back of the N-pole and S-pole of the permanent magnets 26 are alternately arranged for each adjacent pair of magnetic poles 40, and the coils are formed by single-layer distributed winding.

As shown in FIGS. 1 and 2, a plurality of cavity holes (hollow portions) 30 are formed in the rotor core 24. The cavity holes 30 each extend to penetrate through the rotor core 24 along its axial direction. The cavity hole 30 is located at substantially a diametrical center of the rotor core 24 on the respective q-axis and between two respective embedding holes 34 of each adjacent pair of magnetic poles. The cavity holes 30 each have a polygonal, for example, triangular cross-section. The cross section of each cavity hole 30 includes one side normal to the respective q axis and two sides opposing the respective embedding holes 34 each with an interval therebetween. The cavity holes 30 each function as a flux barrier which makes it difficult for magnetic flux to pass through, and they regulate flow of the interlinkage flux of the stator 12 and flow of the magnetic flux of each permanent magnet 26. Further, with the cavity holes 30, the weight of the rotor core 24 can be reduced.

As shown in FIGS. 2 and 3, in this embodiment, a plurality of grooves 50 are formed in the outer circumferential surface of the rotor core 24. The grooves 50 each are formed in a position including the respective q-axis in the outer circumferential surface. Further, the grooves 50 extend parallel to the central axis CL over the full axial length of the rotor core 24.

As seen in FIG. 2, the grooves 50 each are formed in the position including a point P where the respective q-axis and the outer circumferential surface intersect each other and protrude from the outer circumferential surface to a central axis CL side. In this embodiment, the grooves 50 are formed to have an arc-shaped bottom surface. The bottom surfaces of the grooves 50 each are formed into a circular arc shape having its center on the respective q-axis. That is, the grooves 50 have such a configuration that the vertex of the circular arc of each bottom surface is located on the respective q-axis, and the position on the q-axis is the deepest portion thereof.

The grooves 50 are formed into a size (width) which does not overlap the embedding holes 34 (here, it is the outer circumferential-side cavity 34c) or the permanent magnets 26 along the diametrical direction of the rotor core 24. For example, let us suppose an intersection Q set between an imaginary linear line L1 tangent to the outer circumferential-side edge of the respective embedding hole 34 or permanent magnet 26 in FIG. 2, or tangent to the outer circumferential-side cavity 34c in this embodiment and passing through the central axis CL, and the outer circumferential surface of the rotor core 24. Here, a side edge (one lateral end) of each groove 50 is provided at a position shifted from the intersection Q towards the respective q-axis side.

When A is defined as the pole arc degree of the grooves 50, equivalent to the width thereof along the outer circumferential surface, B is defined as the depth (the maximum depth) of the grooves 50 taken from the outer circumferential surface, C is defined as the pole arc degree between each pair of imagination linear lines L1 located on the respective sides of the respective d-axis, and R is defined as the circumradius of the circumference of the rotor core 24, each groove 50 is formed to satisfy the relationships:

0.05<A<0.075 and 0.005<B/R<0.027

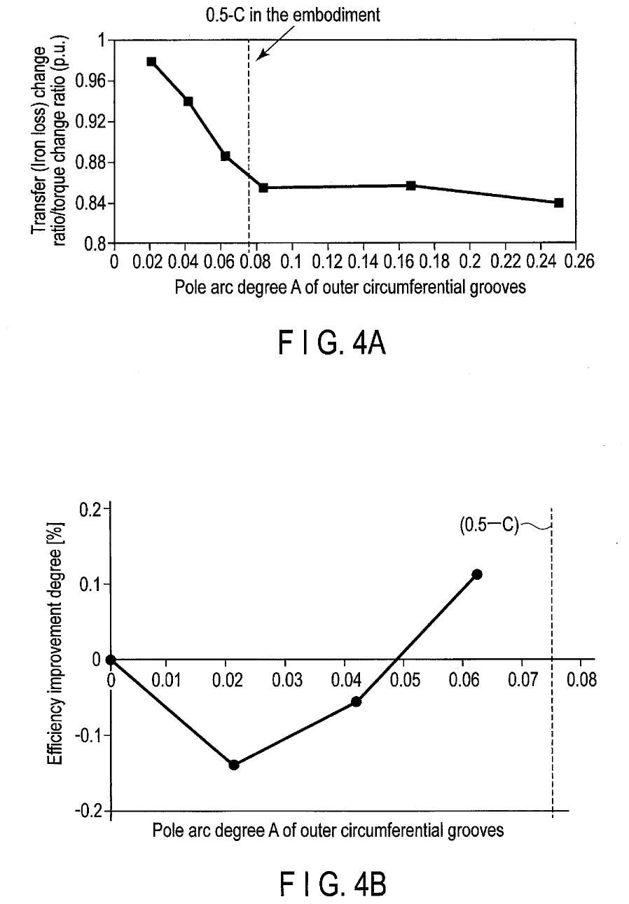

As described above, with the grooves 50 formed in the outer circumferential surface of the rotor core 24, the iron loss of the rotary electric machine 10 can be reduced, and the efficiency can be improved. FIG. 4A shows the relationship between the change ratio of the iron loss/the torque change ratio of the rotary electric machine 10(, which is equivalent to the efficiency of the rotary electric machine) and the pole arc degree A of the grooves. FIG. 4B shows the relationship between the pole arc degree A of the grooves and the efficiency improvement value of the rotary electric machine. As can be seen from FIG. 4A, when the grooves 50 are provided on the respective q-axes, (the iron loss change ratio/the torque change ratio) increases monotonically from 1, that is, the efficiency of the rotary electric machine is raised by increasing the pole arc degree A equivalent to the width of the grooves 50. But, when the pole arc degree A increases to a certain extent, for example, the pole arc degree becomes 0.08, thereafter, the effect by reduction of the iron loss reaches its limit. This is when the width of the grooves 50 increases over to a position intersecting the intersection Q where the imaginary linear line L1 and the outer circumferential surface intersect each other, or a position including the intersection Q, that is, when each groove 50 is located to overlap the respective outer circumferential-side cavity 34c or permanent magnet 26 along the diametrical direction. In such a range of the pole arc degree A, a decrement in iron loss cannot be expected with respect to the change in torque. For this reason, in this embodiment, the upper limit of the pole arc degree A of the grooves 50 is set to (0.5−C)≈0.075, based on the pole arc degree C. between the respective pair of imaginary linear lines L1 located on respective sides of the respective d-axis. Here, (0.5) is equivalent to the pole arc degree of one magnetic pole, that is, the pole arc degree between two q-axes adjacent to each other.

As shown in FIG. 4B, according to the relationship between the pole arc degree A and the efficiency of the rotary electric machine, when the pole arc degree A is greater than 0.05, the efficiency improvement value increases, that is, the efficiency is improved. However, even if the pole arc degree A is increased to a degree discussed above (FIG. 4A), when the pole arc degree A exceeds (0.5−C), calculated based on the pole arc degree C. between a pair of imaginary linear lines L1 located on respective sides of the respective d-axis, the decrement in iron loss cannot be expected with respect to the change in torque. Further, when the degree exceeds this value, the groove 50 invades the respective magnetic path slender portion 38 (the bridge portion) to narrow the slender portion 38. Therefore, in consideration of the possibility of a problem in productivity, the upper limit of the efficiency improvement is set as (0.5−C)≈0.075.

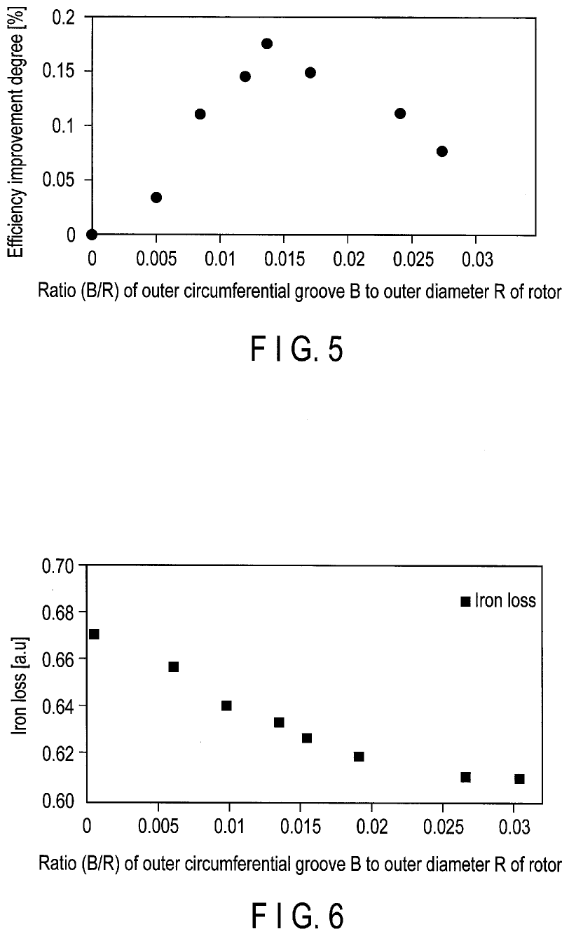

With the grooves 50 provided in the outer circumferential surface, the iron loss is decreased, but the torque is also decreased. Therefore, when examined in the same operating point, the copper loss is increased. The loss related to the efficiency of the rotary electric machine is a total of the copper loss and the iron loss. Therefore, the depth B of the grooves 50 needs to be set in consideration of the iron loss and the copper loss. FIG. 5 shows results of examination of the optimal depth of the groove 50, which illustrates the relationship between the ratio of the depth B of the grooves to the circumradius R of the rotor core 24, (B/R) and the efficiency improvement value of the rotary electric machine. As can be seen from this diagram, the effect of improving the efficiency can be obtained by setting the groove depth B (B/R) in a range of: 0.005<(B/R)<0.027.

FIGS. 6, 7 and FIG. 8 show the relationships between the ratio (B/R) of the groove depth B to the circumradius R of the rotor core 24 and the iron loss, iron loss and motor loss, respectively. Each diagram is provided based on standardization of iron loss value and copper loss value on an assumption that the motor loss of the rotary electric machine of a base model in which the outer circumferential grooves 50 are not provided, is set as 1. Note that in FIG. 8, the motor loss is a total of the copper loss and the iron loss (copper loss+iron loss=motor loss).

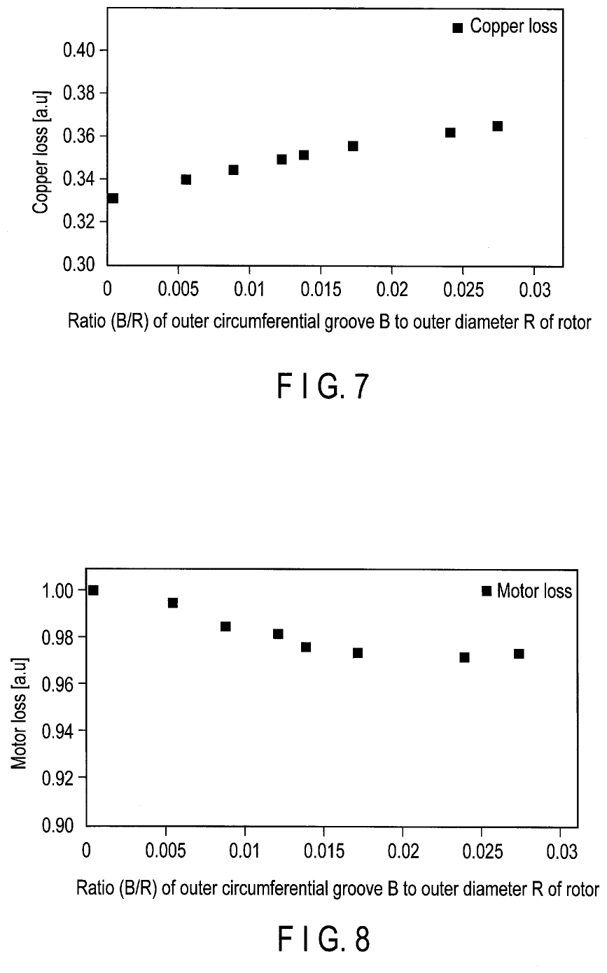

With the grooves 50 provided in the rotor core 24, the torque of the rotary electric machine is decreased. For this reason, a larger current is required to achieve the torque same as the base model in the operating point to calculate the efficiency value (a predetermined torque and a predetermined number of revolutions). Therefore, as seen in FIG. 7, when the current value applied to the coils is increased, the copper loss increases as the depth of the grooves 50 is greater.

As seen in FIG. 6, the iron loss is decreased in comparison with the base model as the depth of the grooves 50 is greater. This is considered because higher components of the eddy current loss in the stator teeth, which will be described later, are decreased.

Further, as can be seen from FIGS. 6, 7 and 8, with the grooves 50 provided, the decrease portion of the iron loss value is larger than the increase portion of the copper loss value, and therefore the total motor loss is smaller than the motor loss of the base model. As a result, the efficiency can be improved.

The reduction in iron loss, described above, will now be described. The iron loss can be categorized into a hysteresis loss and an eddy-current loss. The hysteresis loss is a loss when the magnetic domain of the iron core changes the direction of the magnetic field by an alternating field, and the eddy-current loss is a loss which occurs by an eddy current occurring in the iron core. In this examination, it is considered that the iron loss is reduced particularly by decreasing the harmonic components in the latter eddy current loss.

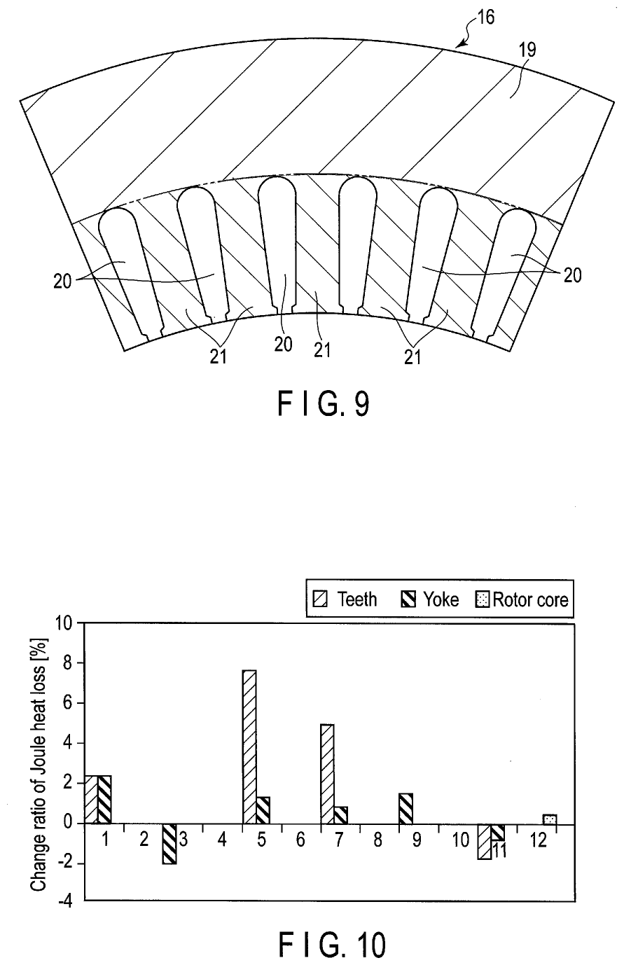

FIG. 10 shows the change ratio in eddy current loss in the stator teeth, yoke and rotor core (core) of the rotary electric machine for each degree. As shown in FIG. 9, the stator teeth correspond to the teeth 21 formed between the respective slots 20 of the stator core 16, and the yoke 19 corresponds to the range between outer circumferential-side edges of the slots 20 and the outer circumferential surface of the stator core 16. As can be seen from FIG. 10, with the grooves 50 provided in the outer circumferential surface of the rotor core 24, the eddy current loss of all portions is decreased.

A principle of suppressing the eddy current loss of the iron core in this embodiment will be described. The eddy current loss in the iron core occurs due to the change in magnetic flux density with time, and when the phenomenon is periodic, the loss is proportional to a square of each of the amplitude and frequency. The change in magnetic flux density synchronized to the frequency of exciting the rotary electric machine is essential to obtain a torque, whereas the harmonic components do not contribute to the generation of the torque but causes a factor of the above-described eddy current loss. In this embodiment, with the grooves 50 of an appropriate outer circumferential shape, the harmonic magnetic flux in the iron core can be suppressed, thereby making it possible to reduce the eddy current loss.

Further, this embodiment is particularly subjected to the suppression of the eddy current loss occurring in the stator teeth 21, and now the principle of suppressing the harmonic magnetic flux, which is a factor thereof, will be described. As a basic principle, the behavior of the magnetic flux generated by the armature reaction is determined by a product of the magnetomotive force of the armature reaction and the permeance. Here, when the armature coil is excited by three-phase alternating current conduction of frequency fe, a magnetomotive force which pulsates at the same frequency fe as that of the exciting current is generated in a certain stator tooth 21. As viewed from the magnetomotive force, the permeance pulsates in sync with the rotation of the rotor. The rotary electric machine is of a general synchronous type, and it rotates by a machine angle for the portion of two poles per one excitation period. Thus, the permeance pulsates at 2 fe as a fundamental frequency. The permeance contains harmonic components, and therefore in this embodiment, the surface is cut (to form the grooves 50), and thus harmonic components pulsate at a frequency 6 fe are decreased. The harmonic magnetic flux generated by the magnetomotive force pulsating at a frequency fe and the permeance pulsating at a frequency 6 fe appears at a frequency of 6 fe±fe by modulation effect. By the above-described principles, the eddy current loss due to the fifth- and seventh-degree harmonic components are suppressed.

According to the permanent magnet-type rotary electric machine 10 described above, as an electric current is allowed to flow through the armature coils 18, the interlinkage flux generated from the armature coil 18 and the magnetic field generated from the permanent magnets 26 interact each other to rotate the rotor 14 around the shaft 22. Further, the rotary electric machine 10 is driven to rotate by a synthesized torque of the reluctance torque to minimize the magnetic path where the magnetic flux passes and the magnet torque due to an attractive force and a repulsive force created between the stator 12 and the permanent magnets 26. Thus, the rotary electric machine 10 can output the mechanical energy from the shaft 22 which rotates integrally with the rotor 14, by using the electrical energy input by the conduction of the current.

With the structure that a plurality of grooves 50 are formed in the outer circumferential surface of the rotor core 24 and at positions including the respective q-axes and further to satisfy the relationships: 0.05<A<0.075 and 0.005<B/R<0.027, the iron loss of the rotary electric machine 10 can be reduced, thereby improving the efficiency of the machine.

As described above, according to the present embodiment, a permanent magnet-type rotary electric machine with improved efficiency can be obtained.

The present invention is not limited to the embodiments described above, and the constituent elements of the invention can be modified in various ways without departing from the spirit and scope of the invention. Various aspects of the invention can also be extracted from any appropriate combination of constituent elements disclosed in the embodiments. For example, some of the constituent elements disclosed in the embodiments may be deleted. Furthermore, the constituent elements described in different embodiments may be arbitrarily combined.

For example, the number of magnetic poles, dimensions, shape and the like of the rotor are not limited to the embodiments described above, but can be variously changed depending on design. The cross-section of the inner circumferential-side cavities, outer circumferential-side cavities and the cavity holes are not limited to the shapes discussed in the embodiments, but can be selected from various kinds of shapes. In each magnetic pole, the number of permanent magnets is not limited to a pair, but may be three or more.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rotary electric machine comprising:
a stator; and
a rotor provided rotatably around a central axis, the rotor comprising a rotor core comprising an outer circumferential surface opposing the stator with a gap therebetween and a plurality of magnetic poles arranged along the outer circumferential surface, and a plurality of permanent magnets provided in each of the plurality of magnetic poles,
where, in the rotor core, axes each radially extending to pass through a boundary between each respective adjacent pair of two magnetic poles and the central axis, being q-axes, and axes at an electrical angle of 90 degrees with respect to the respective q-axes being d-axes,
the rotor core comprising, in each magnetic pole, two embedding holes provided on respective sides of the respective d-axis, in which the respective permanent magnets are loaded, respectively, and a plurality of grooves formed in the outer circumferential surface in positions including the respective q-axes to project to an inner circumferential side of the rotor core,
the two embedding holes and two permanent magnets each comprising an inner circumferential-side edge adjacent to the respective d-axes and an outer circumferential-side edge adjacent to the outer circumferential surface, being arranged to be line symmetrical with respect to the respect d-axis and also such that a distance from the respective d-axis gradually expands from the inner circumferential-side edge towards the outer circumferential-side edge, and
where A represents a pole arc degree of the grooves along the outer circumferential surface, B represents a depth of the grooves from the outer circumferential surface, and R represents a circumradius tangent to an outer circumference of the rotor core, each of the grooves is formed to satisfy relationships:
0.05<A<0.075, and
0.005<B/R<0.027.

2. The rotary electric machine of claim 1, wherein each of the plurality of grooves is defined by an arc-shaped bottom surface having a center thereof on the respective q-axis.

3. The rotary electric machine of claim 2, wherein each of the plurality of grooves extends in an axial direction of the rotor core.

4. The rotary electric machine of claim 1, wherein each of the plurality of grooves extends in an axial direction of the rotor core.
